(19) United States
(12) Patent Application Publication
(10) Pub. No.: US 2007/0226173 A1
(43) Pub. Date: Sep. 27, 2007

(54) Content-Processing Device and Content-Processing Method

(76) Inventor: Masaki Sakamoto, Iwaki-city (JP)

Correspondence Address: BRINKS HOFER GILSON & LIONE, P.O. BOX 10395, CHICAGO, IL, 60610, US

(21) Appl. No.: 11/682,125

(22) Filed: Mar. 5, 2007

(30) Foreign Application Priority Data
Mar. 24, 2006 (JP) 2006-082429

(51) Int. Cl. G06F 17/30

(52) U.S. Cl. 707/1

(57) ABSTRACT

Content-list-display-processing devices configured to produce a list of contents on a display unit are disclosed. Further, rights-management-standard-display-processing devices that provide for displaying information about at least one rights-management standard for managing contents and displaying the content list on a display unit so that each of the at least one rights-management standard is shown in association with each of the contents shown on the content list are disclosed.

### RELATED APPLICATIONS

The present application claims priority to Japanese Patent Application Serial Number 2006-082429, filed Mar. 24, 2006, the entirety of which is hereby incorporated by reference.

### BACKGROUND OF THE INVENTION

1. Field of the Invention

The present invention relates to a content-processing device and a content-processing method, and particularly relates to a content-processing device and a content-processing method that are suitable for processing contents managed by various rights-management standards.

2. Description of the Related Art

Traditionally, in an on-vehicle device or the like, application-specific software programs that support rights-management standards are used to perform operations on contents, including music contents or the like, such as making a copy of the contents or transfering the contents.

For example, Windows™ digital rights management (DRM), iTunes™, adaptive-transform-acoustic-coding (ATRAC) audio device (AD)™, Information Versatile Disk for Removable usage (iVDR)™, and so forth have been known, as the above-described rights-management standard.

The above-described technologies are disclosed in Japanese Unexamined Patent Application Publication No. 2001-291365, for example.

However, all contents acquired by a user are not necessarily managed by the same rights-management standard at the same time. Namely, when the user acquires a plurality of contents, each of the plurality of contents is often managed by different rights-management standards.

In that case, rights-management standards may vary with different connectable devices or details on the content transfer and copy restrictions may vary. Therefore, when performing processing for the contents, the user needs to check which rights-management standard is used for each of the contents and understand what kind of processing is permitted for each rights-management standard. Accordingly, an increased load is placed on the user when the user performs processing for the contents.

### SUMMARY OF THE INVENTION

It is an object of the present invention to increase convience for a user by providing a content-processing device and a content-processing method that allow the user to easily perform executable processing for contents, the executable processing being appropriate for a rights-management standard.

A content-processing device according to an embodiment of the present invention includes a content-storage device configured to store contents, a rights-management-standard-storage device configured to store information about at least one rights-management standard by which a right of the stored contents is managed, an additional-information-storage device configured to store additional information about the stored contents, a content-list-display-processing device configured to produce a list of the stored contents on a display unit by using the stored additional information, and a rights-management-standard-display-processing device configured to produce the stored rights-management-standard information and the content list on the display unit so that each of the at least one rights-management standard is shown in association with each of the contents shown on the content list. According to the above-described configuration, the rights-management-standard-display-processing device can display the at least one content-rights-management standard and the content list so that each of the at least one rights-management standard is shown in association with each of the contents shown on the content list.

Further, a content-processing device according to another embodiment of the present invention includes a content-storage device configured to store contents, a rights-management-standard-storage device configured to store information about at least one standard by which a right of the stored contents is managed, an additional-information-storage device configured to store additional information about the stored contents, and a content-individual-list-display-processing device configured to produce a list of the stored contents on a display unit by using the stored additional information and the stored rights-management-standard information so that the content list is individually produced for each of the at least one rights-management standard. According to the above-described configuration, the content-individual-list-display-processing device can display the content list so that the content list is individually shown for each of the at least one rights-management standard.

Further, a content-processing device according to another embodiment of the present invention includes a content-storage device configured to store contents, a rights-management-standard-storage device configured to store information about at least one standard by which a right of the stored contents is managed, a rights-management-standard-list-display-processing device configured to produce a list of the at least one rights-management standard on a display unit on the basis of the stored rights-management-standard information so that a user can select any of the at least one rights-management standard shown on the rights-management-standard list, and an executable-processing-option-display-processing device configured to produce both an option list and a content list on the display unit when the user selects any of the at least one rights-management standard shown on the produced rights-management-standard list, where the option list shows at least one option indicating processing executable for contents managed by the selected rights-management standard and where the content list shows the contents managed by the selected rights-management standard. According to the above-described configuration, when the user selects any of the at least one rights-management standard shown on the rights-management-standard list produced by the rights-management-standard-list-display-processing device, the executable-processing-option-display-processing device can produce the list of the at least one option indicating processing executable for the contents managed by the rights-management standard selected by the user and the list of the contents managed by the selected rights-management standard.

In the above-described content-processing device, the executable-processing-option-display-processing device may display the list of the contents managed by the selected rights-management standard so that the user can select any of the contents shown on the content list and the list of the at least one option indicating the processing executable for the contents managed by the selected rights-management standard so that the user can select any of the at least one option shown on the option list. The above-described content-processing device may further include a content-processing-execution device configured to execute processing indicated by an option for contents when the user selects the contents from among the list of the contents managed by the selected rights-management standard and the option from among the list of the at least one option indicating the processing executable for the contents managed by the selected rights-management standard. According to the above-described configuration, when the user selects any of the contents from among the list of the contents managed by the selected rights-management standard and any of the at least one option from among the option list showing the processing executable for the contents managed by the selected rights-management standard, the content-processing-execution device can execute the processing indicated by the selected option for the selected contents.

Further, in the above-described content-processing device, the executable-processing-option-display-processing device may display the list of the at least one option indicating the processing executable for the contents managed by the selected rights-management standard so that the list can be individually produced for each of the contents managed by the rights-management standard.

Further, in the above-described content-processing device, the rights-management-standard-list-display-processing device may display at least one classification category indicating contents that are not managed by the rights-management standard on the content-rights-management-standard list so that the user can select any of the at least one classification category. Further, when the user selects the classification category indicating the contents that are not managed by the rights-management standard from among the content-rights-management-standard list, the executable-processing-option-display-processing device may display both a list of at least one option indicating processing executable for the contents that are not managed by the rights-management standard and that belong to the classification category, and a list of the contents that are not managed by the rights-management standard on the display unit. According to the above-described configuration, when the user selects the classification category indicating the contents that are not managed by the rights-management standard from among the content-rights-management-standard list produced by the rights-management-standard-list-display-processing device, the executable-processing-option-display-processing device can produce the list of the at least one option indicating the processing executable for the contents that are not managed by the rights-management standard and that belong to the classification category, and the list of the contents that are not managed by the rights-management standard.

Further, in the above-described content-processing device, the executable-processing-option-display-processing device may display the list of the contents that are not managed by the rights-management standard so that the user can select any of the contents shown on the content list, and the list of the at least one option indicating the processing executable for the contents that are not managed by the rights-management standard so that the user can select any of the at least one option shown on the option list. The above-described content-processing device further includes a content-processing-execution unit configured to execute processing indicated by an option for contents when the user selects the contents from among the list of the contents that are not managed by the rights-management standard and the option from among the list of the at least one option indicating the processing executable for the contents that are not managed by the rights-management standard. According to the above-described configuration, when the user selects the contents from among the list of the contents that are not managed by the rights-management standard and the option from among the list of the at least one option indicating the processing executable for the contents that are not managed by the selected rights-management standard, the content-processing-execution device can execute the processing indicated by the selected option for the selected contents.

Further, in the above-described content-processing device, the contents may include at least one of sound data and video data. According to the above-described configuration, the rights-management-standard-display-processing device can display information about at least one standard by which the right of sound and/or video contents is managed so that each of the at least one standard is shown in association with each of the contents shown on the list of the sound and/or video contents.

Further, in the above-described content-processing device, the contents may be provided, as music contents and the additional information includes at least one of track-title information, track-type information, and information about an artist's name. According to the above-described configuration, the rights-management-standard-display-processing device can display the list of the music contents including at least one of the track-title information, the track-type information, and the information about an artist's name, and the information about the at least one rights-management standard by which the rights of the music contents is managed so that each of the at least one rights-management standard is shown in association with each of the music contents shown on the music-content list.

Further, the above-described content-processing device may be mounted on an on-vehicle device. According to the above-described configuration, the rights-management-standard-display-processing device mounted on the on-vehicle device can display the content list and the at least one rights-management standard by which the right of the contents is managed so that each of the at least one rights-management standard is shown in association with each of the contents shown on the content list.

In a content-processing method according to another embodiment of the present invention, when a list of contents is shown on a display unit by using additional information about the contents, both information about at least one rights-management standard by which a right of the contents is managed and the content list are shown on the display unit so that each of the at least one right-management standard is shown in association with each of the contents shown on the content list. By using the above-described method, it becomes possible to show both the content list and the content-rights-management-standard information so that each of the at least one rights-management standard is shown in association with each of the contents shown on the content list.

When a content-processing method according to another embodiment of the present invention is used, a list of contents is shown on a display unit by using additional information about the contents and information about at least one rights-management standard by which a right of the contents is managed so that the content list is individually shown for each of the at least one content-rights-management standard. By using the above-described method, the content list can be shown individually for each of the at least one rights-management standard.

Further, a content-processing method according to another embodiment of the present invention includes the steps of producing a list of at least one rights-management standard by which a right of contents is managed on a display unit so that a user can arbitrarily select any of the at least one rights-management standard shown on the rights-management-standard list, and producing both an option list and a content list on the display unit when the user selects any of the at least one rights-management standard from among the produced content-rights-management-standard list, where the option list shows at least one option indicating processing executable for contents managed by the selected rights-management standard and where the content list shows the contents managed by the selected rights-management standard. By using the above-described method, when the user selects any of the at least one rights-management standard shown on the rights-management-standard list, both the list of the at least one option indicating the processing executable for the contents managed by the selected rights-management standard and the list of the contents managed by the selected rights-management standard can be displayed.

The above-described content-processing method may further include the steps of producing the list of the contents managed by the rights-management standard selected by the user so that the user can select any of the contents shown on the content list and producing the list of the at least one option indicating the processing executable for the contents managed by the selected rights-management standard so that the user can select any of the at least one option shown on the option list, and executing processing indicated by an option for contents when the user selects the arbitrary contents from among the list of the contents managed by the rights-management standard selected by the user and the option from among the list of the at least one option indicating the processing executable for the contents managed by the selected rights-management standard. Accordingly, when the user selects any of the contents shown on the list of the contents managed by the rights-management standard selected by the user and any of the at least one option from among the list of the at least one option indicating the processing executable for the contents managed by the rights-management standard selected by the user, the processing indicated by the option selected for the arbitrarily selected contents can be executed.

The above-described content-processing method may further include the step of producing the list of the at least one option indicating the processing executable for the contents managed by the rights-management standard selected by the user so that the list is individually produced for each of the contents managed by the rights-management standard. Accordingly, it becomes possible to display the list of the at least one option indicating the processing executable for the contents managed by the rights-management standard selected by the user so that the option list can be displayed individually for each of the contents managed by the rights-management standard.

The above-described content-processing method may further include the steps of producing at least one content-classification category indicating contents that are not managed by the rights-management standard on the content-rights-management-standard list so that the user can select any of the at least one classification category, and producing a list of at least one option and a list of the contents that are not managed by the rights-management standard on the display unit when the user selects the content-classification category indicating the contents that are not managed by the rights-management standard from among the content-rights-management-standard list, where the option list shows processing executable for the contents that belong to the classification category and that are not managed by the rights-management standard. Accordingly, when the user selects the content-classification category indicating that the contents are not managed by the rights-management standard from among the rights-management-standard list, both the list of the at least one option indicating processing executable for contents that belong to the classification category and that are not managed by the rights-management standard, and the list of the contents that are not managed by the rights-management standard can be displayed.

Further, the above-described content-processing method may further include the steps of producing the list of the contents that are not managed by the rights-management standard so that the user can arbitrarily select any of the contents shown on the content list and producing the list of the at least one option indicating the processing executable for the contents that are not managed by the rights-management standard so that the user can select any of the at least one option shown on the option list, and executing processing indicated by an option for contents when the user selects the contents from among the list of the contents that are not managed by the rights-management standard and the option from among the list of the at least one option indicating the processing executable for the contents that are not managed by the rights-management standard. Accordingly, when the user selects any of the contents from among the list of the contents that are not managed by the rights-management standard and the option from among the list of the at least one option indicating the processing executable for the contents that are not managed by the rights-management standard, the processing indicated by the selected option can be executed for the selected contents.

When the above-described content-processing method is used, the contents may include at least one of sound data and video data. Accordingly, it becomes possible to display a list of sound and/or video contents, and information about at least one rights-management standard by which the right of the sound and/or video contents is managed so that the rights-management-standard information is shown in association with each of the contents shown on the list of the sound and/or video contents.

According to the above-described content-processing method, the contents may be provided, as music contents, and the additional information may include at least one of track-title information, track-type information, and information about an artist's name. The use of the above-described method allows for displaying the list of the music contents including at least one of the track-title information, the track-type information, and the information about an artist's name, and the information about the at least one rights-management standard by which the rights of the music contents is managed so that each of the at least one rights-management standard is shown in association with each of the music contents shown on the music-content list.

Further, the above-described content-processing method may be used in an on-vehicle device. The use of the above-described method allows for displaying the content list and the at least one rights-management standard by which the right of the contents is managed in the on-vehicle device so that each of the at least one rights-management standard is shown in association with each of the contents shown on the content list.

The present invention allows for displaying the content list and the at least one rights-management standard by which the right of the contents is managed so that each of the at least one rights-management standard is shown in association with each of the contents shown on the content list. Therefore, the user can easily find the rights-management standard corresponding to the contents. As a result, the user can easily perform executable processing for the contents, the executable processing being appropriate for the rights-management standard, which increases the convenience of the user.

Further, the present invention allows for individually showing the content list for each of the at least one rights-management standard. As a result, the user can easily perform the executable processing for each of the contents shown on the content list, the executable processing being appropriate for the rights-management standard, which increases the convenience of the user.

Further, according to an embodiment of the present invention, when the user selects any of the at least one rights-management standard from among the rights-management-standard list, both the list of the at least one option indicating the processing executable for the contents managed by the selected rights-management standard and the list of the contents managed by the selected rights-management standard are shown. Therefore, the user can easily find the rights-management standard by which the right of the contents is managed and the processing executable for the contents. As a result, the user can perform the executable processing for the contents with increased facility and stability, the executable processing being appropriate for the rights-management standard.

Further, according to the above-described embodiment of the present invention, when the user selects any of the contents from among the list of the contents managed by the selected rights-management standard and any of the at least one option from among the option list showing the processing executable for the contents managed by the selected rights-management standard, the processing indicated by the selected option is executed for the selected contents. As a result, the user can easily perform the executable processing for the contents, the executable processing being appropriate for the rights-management standard, and the convenience of the user can be further increased.

Further, according to the above-described embodiment of the present invention, it becomes possible to display the list of the at least one option indicating the processing executable for the contents managed by the rights-management standard selected by the user so that the list can be individually produced for each of the contents managed by the rights-management standard. Therefore, even though a plurality of contents are managed by the same rights-management standard, and processing executable for one of the plurality of contents may be different from that executable for the other contents, the executable processing can be performed for each of the contents with facility and stability.

Further, according to the above-described embodiment of the present invention, when the user selects the classification category indicating the contents that are not managed by the rights-management standard from among the rights-management-standard list, the list of the at least one option indicating the processing executable for the contents that are not managed by the rights-management standard and that belong to the classification category, and the list of the contents that are not managed by the rights-management standard are displayed. Therefore, the user can easily find the executable processing corresponding to the contents that are not managed by the rights-management standard. As a result, the user can perform the executable processing for the contents that are not managed by the rights-management standard with facility and stability.

Further, according to the above-described embodiment of the present invention, when the user selects the contents from among the list of the contents that are not managed by the rights-management standard and the option from among the list of the at least one option indicating the processing executable for the contents that are not managed by the rights-management standard, the processing indicated by the selected option is executed for the selected contents. As a result, the user can perform the executable processing for the contents that are not managed by the rights-management standard with increased facility, so that the convenience of the user further increases.

The present invention can be used for contents including sound data, such as the music contents, contents including video data, and/or contents including both the sound data and the video data.

When the present invention is used for the music contents, and the list of the music contents including at least one of the track-title information, the track-type information, and the information about an artist's name, and the information about the at least one rights-management standard by which the right of the music contents is managed are displayed, the user can easily perform desired processing for favorite music contents.

The present invention can be further used for the on-vehicle device.

### BRIEF DESCRIPTION FOR THE DRAWINGS

FIG. 1 is a block diagram showing one embodiment of a content-processing device;

FIG. 2 shows one illustration of a total-display screen image produced using a content-processing device and a content-processing method;

FIG. 3 shows one illustration of a rights-management-standard-individual-display screen image produced using a content-processing device and a content-processing method;

FIG. 4 shows one illustration of a first individual-list-and-executable-processing-option-display screen image produced using a content-processing device and a content-processing method; and

FIG. 5 shows one illustration of a second individual-list-and-executable-processing-option-display screen image produced using a content-processing device and a content-processing method.

### DESCRIPTION OF THE PREFERRED EMBODIMENTS

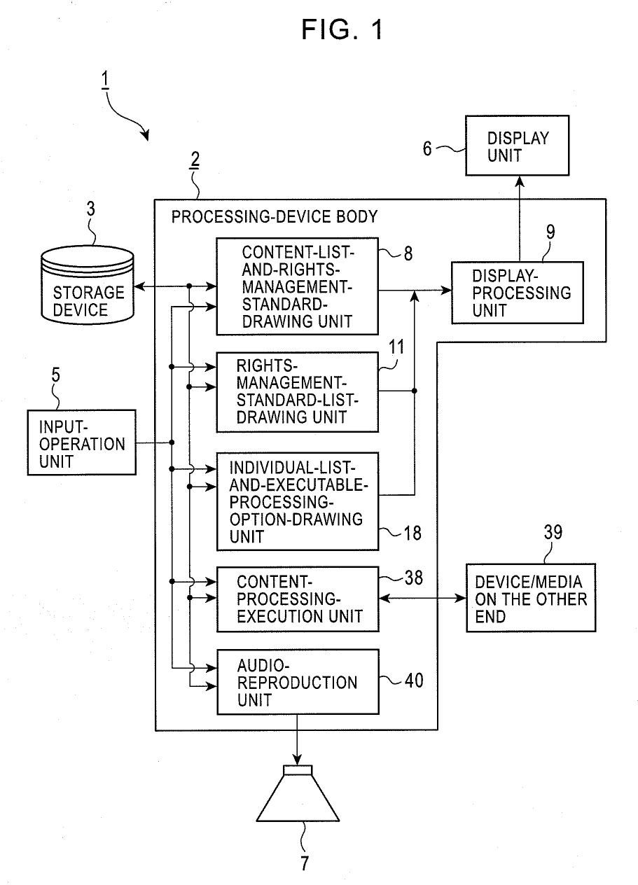

A content-processing device 1 is described below with reference to FIGS. 1, 2, 3, 4, and 5. As shown in FIG. 1, the content-processing device 1 may includes a processing-device body 2, and a storage device 3, an input-operation unit 5, a display unit 6, and a sound-output unit 7 that are connected to the processing-device body 2.

The storage device 3 may be provided as a hard-disk drive and/or a digital-versatile-disk (DVD)/compact-disk (CD) drive into which a DVD and/or a CD is inserted. The input-operation unit 5 may be provided, as a remote-control unit, a touch panel, a linear encoder, and so forth.

The storage device 3 functions as a content-storage device. Music contents or contents including sound data are stored in the storage device 3. The storage device 3 further functions as a rights-management-standard-storage device. The storage device 3 stores both the music contents and information about a rights-management standard by which the right of the music contents is managed. Further, the storage device 3 functions as an additional-information-storage device storing additional information about the music contents. The additional information may include information about the title and genre of a track, and the artist's name.

The processing-device-body 2 includes a content-list-and-rights-management-standard-drawing unit 8 to which the storage device 3 and the input-operation unit 5 are connected. The content-list-and-rights-management-standard-drawing unit 8 functions as a content-list-display-processing device and a rights-management-standard-display-processing device. That is to say, the content-list-and-rights-management-standard-drawing unit 8 reads the additional information about the music contents, the additional information being stored in the storage device 3, and information about the rights-management standard by which the music contents stored in the storage device 3 is managed.

The content-list-and-rights-management-standard-drawing unit 8 generates content-list-and-rights-management-standard-drawing data by using the additional information and the rights-management-standard information that are read from the storage device 3. The content-list-and-rights-management-standard-drawing data is provided so that at least the list of the music contents stored in the storage device 3 is displayed.

Further, the content-list-and-rights-management-standard-drawing data is provided to display the at least one rights-management standard by which the right of the music contents shown on the music-contents list is managed and to display the music-content list so that each of the at least one rights-management standard is shown in association with the music contents.

The content-list-and-rights-management-standard-drawing unit 8 outputs the generated content-list-and-rights-management-standard-drawing data to the display-unit-6 side. A display-processing unit 9 is connected to the output of the content-list-and-rights-management-standard-drawing unit 8 and the input of the display unit 6. The display-processing unit 9 and the content-list-and-rights-management-standard-drawing unit 8 function as a content-list-display-processing device and a rights-management-standard-display-processing device.

The content-list-and-rights-management-standard-drawing data output from the content-list-and-rights-management-standard-drawing unit 8 is transmitted to the display-processing unit 9. Then, the display-processing unit 9 converts the transmitted content-list-and-rights-management-standard-drawing data into image data and produces an image of the image data on the display unit 6.

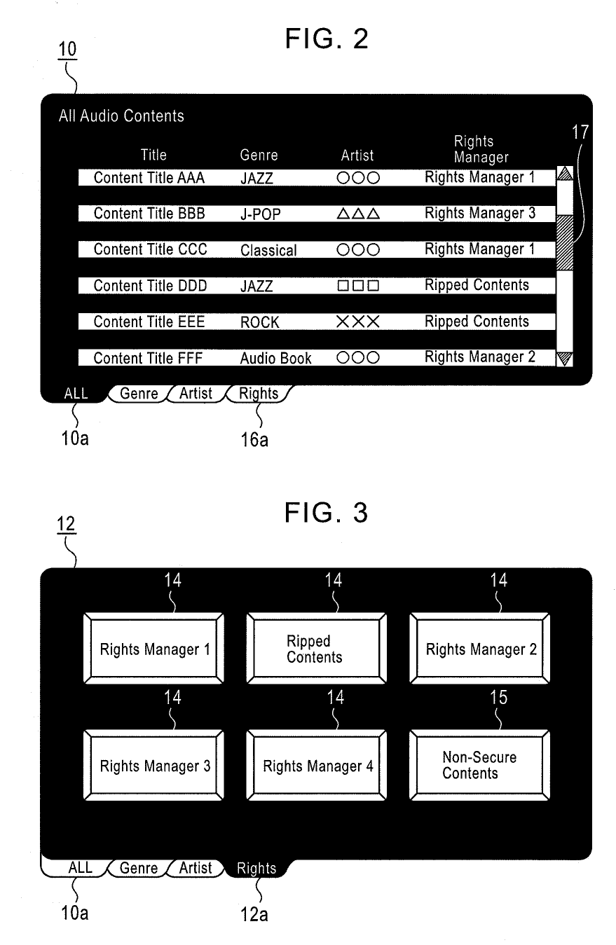

Subsequently, the display unit 6 shows the list of music contents corresponding to a plurality of tracks on the screen image 10, where the list shows the title and genre of each of the tracks and the artist's names, as shown in FIG. 2. Further, the display unit 6 also shows the rights-management-standards by which the rights of the music contents shown on the list are managed on the screen image 10 so that each of the rights-management-standards is shown in association with each of the contents. Each of the rights-management-standards is shown, as a message which reads Rights Manager, as shown in FIG. 2.

The screen image 10 is provided to show list information about the entire music contents (hereinafter referred to as a total-display screen image 10). When the music contents include a large number of tracks, as shown in FIG. 2, a scroll bar 17 may be shown on the total-display screen image 10 so that a user can scroll the music-content list and see the entire music contents by using the scroll bar 17.

The total-display screen image 10 may be produced by default after the content-processing device 1 is started. Otherwise, when a tag 10a that is shown in FIG. 2 and that is provided to select the total-display screen image 10 is selected by the user operating the input-operation unit 5, the total-display screen image 10 may be changed from a different screen image (e.g., a rights-management-standard-individual-display screen image 12 that will be described later) and produced.

In addition to the above-described configuration, the processing-device body 2 may further include a rights-management-standard-list-drawing unit 11. The storage device 3, the input-operation unit 5, and the display-processing unit 9 are connected to the rights-management-standard-list-drawing unit 11. The rights-management-standard-list-drawing unit 11 functions as a rights-management-standard-list-display-processing device. That is to say, the rights-management-standard-list-drawing unit 11 reads information about a rights-management standard by which the right of the music contents stored in the storage device 3 is managed, and generates rights-management-standard-list-drawing data by using the read information.

The rights-management-standard-list-drawing data is provided to show at least the list of rights-management standards by which the rights of the music contents stored in the storage device 3 are managed. The list is shown in a predetermined manner so that the user can select any of the rights-management standards shown on the list. Further, the rights-management-standard-list-drawing data is provided to show at least content-classification categories on the list of rights-management standards by which the rights of the music contents are managed, where the contents corresponding to the content-classification category are not managed by the rights-management standard. The content-classification categories are shown in a predetermined manner so that the user can select any of the content-classification categories.

The rights-management-standard-list-drawing unit 11 transmits the generated rights-management-standard-list-drawing data to the display-processing unit 9. Both the display-processing unit 9 and the rights-management-standard-list-drawing unit 11 function as a rights-management-standard-list-display-processing device. The display-processing unit 9 converts the rights-management-standard-list-drawing data transmitted from the rights-management-standard-list-drawing unit 11 into an image and produces the image on the display unit 6.

Subsequently, the list of rights-management standards is produced on the display unit 6 as an operation-screen image which allows the user to select any of rights-management standards shown on the list, as shown in FIG. 3. Hereinafter, the operation-screen image will be referred to as the rights-management-standard-individual-display screen image 12. The rights-management-standard list further displays classification categories of music contents, where the classification categories indicates that the music contents are not managed by the rights-management standard, so that the user can select any of the classification categories.

More specifically, the rights-management-standard-individual-display screen image 12 includes a plurality of operation buttons 14 to select each of different rights-management standards that are shown as signs which read Rights Manager 1 to 4 and Ripped Contents, as shown in FIG. 3. The sign Ripped Contents shown in FIG. 3 indicates a rights-management standard provided to manage contents that are ripped by the user and that are difficult to be copied. Then, the user operates any of the operation buttons 14 by operating the input-operation unit 5 to select a desired rights-management standard.

The rights-management-standard-individual-display screen image 12 may include an operation button 15 to select a music-content-classification category indicating that the music contents corresponding to the classification category are not managed by the rights-management standard, where the classification category is shown as a sign which reads Non-Secure Contents, as shown in FIG. 3. Then, the user operates the operation button 15 by operating the input-operation unit 5 to select the music-content-classification category indicating that the music contents corresponding to the classification category are not managed by the rights-management standard.

The rights-management-standard-individual-display screen image 12 may be produced in the following manner. When a different screen image such as the total-display image screen 10 is produced and a tag 12a shown in FIG. 3 is provided to select the rights-management-standard-individual-display screen image 12 through the operation of the input-operation unit 5, the different screen image may be switched to the rights-management-standard-individual-display screen image 12.

In addition to the above-described configuration, the processing-device body 2 may include an individual-list-and-executable-processing-option-drawing unit 18. The storage device 3, the input-operation unit 5, and the display-processing unit 9 are connected to the individual-list-and-executable-processing-option-drawing unit 18. The individual-list-and-executable-processing-option-drawing unit 18 functions as a content-individual-list-display-processing device and an executable-processing-option-display-processing device.

When the user selects a desired rights-management standard by operating the operation button 14 on the rights-management-standard-individual-display screen image 12, the individual-list-and-executable-processing-option-drawing unit 18 reads information about the rights-management standard selected by the user and the additional information about the music contents managed by the rights-management standard selected by the user from the storage device 3. Then, the individual-list-and-executable-processing-option-drawing unit 18 generates first individual-list-and-executable-processing-option-drawing data on the basis of the rights-management-standard information and the additional information that are read from the storage device 3.

The first individual-list-and-executable-processing-option-drawing data shows at least the list of music contents managed by the rights-management standard selected by the user (the individual list) so that the user can select any of the music contents shown on the list.

Further, the first individual-list-and-executable-processing-option-drawing data shows at least the list of options indicating processing executable for the music contents managed by the rights-management standard selected by the user so that the user can select any of the options shown on the list.

The individual-list-and-executable-processing-option-drawing unit 18 transmits the generated first individual-list-and-executable-processing-option-drawing data to the display-processing unit 9. Both the display-processing unit 9 and the individual-list-and-executable-processing-option-drawing unit 18 function as the content-individual-list-display-processing device and the executable-processing-option-display-processing device. The display-processing unit 9 converts the first individual-list-and-executable-processing-option-drawing data transmitted from the individual-list-and-executable-processing-option-drawing unit 18 into an image and produces the image on the display unit 6.

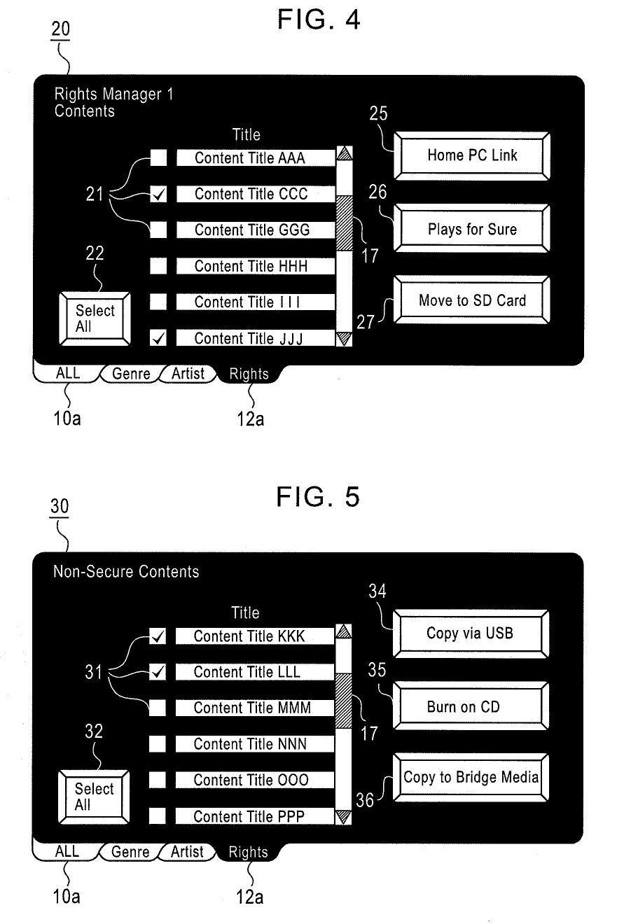

Subsequently, as shown in FIG. 4, the display unit 6 shows the individual list of music contents managed by the rights-management standard selected by the user and the list of options indicating processing executable for the music contents, as an operation-screen image. The above-described lists are shown so that the user can select any of the music contents and/or any of the options shown on the lists. Hereinafter, the above-described operation-screen image will be referred to as a first individual-list-and-executable-processing-option-display screen image 20.

More specifically, the first individual-list-and-executable-option-display screen image 20 illustrated in FIG. 4 shows a list which only shows music contents managed by the rights-management standard Rights Manager 1. The above-described list is shown independently of music contents managed by a different rights-management standard (i.e. individual display).

In the case where the music-content list illustrated in FIG. 4 is shown, each of the music contents can be selected by placing a checkmark in each of checkboxes 21 shown on the list by using the input-operation unit 5, where the checkboxes 21 correspond to the music contents. Further, the music-content list illustrated in FIG. 4 is provided so that the user can select the entire music contents shown on the list at one time by operating an operation button 22 which allows for selecting the entire music contents shown on the list through the input-operation unit 5. The music-content list illustrated in FIG. 4 only includes information about the track titles indicated by signs that read Title and that are shown in FIG. 4. However, the music-content list may include additional information other than the track-title information.

The first individual-list-and-executable-processing-option-display screen image 20 further shows an option of one of the options for processing music contents manged by Rights Manger 1 to make a link to a home personal computer (PC). The above-described option is indicated by a sign which reads Home PC Link shown in FIG. 4. The above-described option may be shown as a selectable operation button 25.

Further, the first individual-list-and-executable-processing-option-display screen image 20 shows an option of one of the options for processing music contents manged by Rights Manger 1 to make a copy of music contents and transmit the copy to a portable-audio device connected to the content-processing device 1. The above-described option is indicated by a sign which reads Plays for Sure shown in FIG. 4. The above-described option may be shown as a selectable operation button 26.

The first individual-list-and-executable-processing-option-display screen image 20 may further show an option of one of the options for processing music contents manged by Rights Manger 1 to move the music contents to a secure-digital (SD) memory card. The above-described option is indicated by a sign which reads Move to SD Card, as shown in FIG. 4. The above-described option may be shown as a selectable operation button 27.

The user can select a desired option by operating any of the operation buttons 25, 26, and 27 by using the input-operation unit 5.

When the user selects a music-content-classification category indicating that the music contents corresponding to the classification category are not managed by the rights-management standard by operating the operation button 15 on the rights-management-standard-individual-display screen image 12, the individual-list-and-executable-processing-option-drawing unit 18 reads the additional information about the music contents belonging to the selected classification category from the storage device 3. Then, the individual-list-and-executable-processing-option-drawing unit 18 generates second individual-list-and-executable-processing-option-drawing data on the basis of the information read from the storage device 3.

The second individual-list-and-executable-processing-option-drawing data shows at least the list of music contents that are not managed by the rights-management standard (the individual list) so that the user can arbitrarily select any of the music contents shown on the list.

Further, the second individual-list-and-executable-processing-option-drawing data shows at least the list of options indicating processing executable for the music contents that are not managed by the rights-management standard so that the user can arbitrarily select any of the options shown on the list.

The individual-list-and-executable-processing-option-drawing unit 18 transmits the generated second individual-list-and-executable-processing-option-drawing data to the display-processing unit 9. The display-processing unit 9 converts the second individual-list-and-executable-processing-option-drawing data transmitted from the individual-list-and-executable-processing-option-drawing unit 18 into an image and produces the image on the display unit 6.

Subsequently, as shown in FIG. 5, the display unit 6 shows the individual list of music contents that are not managed by the rights-management standard and the list of options indicating processing executable for the music contents, as an operation-screen image on which the user can select the above-described music contents and options. Hereinafter, the above-described operation-screen image will be referred to as a second individual-list-and-executable-processing-option-display screen image 30.

More specifically, the second individual-list-and-executable-processing-option-display screen image 30 illustrated in FIG. 5 shows a list which only shows the music contents belonging to a classification category indicating that the music contents are not managed by the rights-management standard. The above-described classification category is shown in FIG. 5, as a sign which reads Non-Secure Contents.

In the case where the music-content list illustrated in FIG. 5 is shown, each of the music contents shown on the list can be selected by placing a checkmark in each of checkboxes 31 shown on the list by using the input-operation unit 5, where the checkboxes 31 correspond to the music contents, as is the case with FIG. 4. Further, the music-content list illustrated in FIG. 5 is provided so that the user can select the entire music contents shown on the list at one time by operating an operation button 32 which allows for selecting the entire music contents shown on the list through the input-operation unit 5, as is the case with FIG. 4. The music-content list illustrated in FIG. 5 only includes information about the track titles indicated by signs that read Title and that are shown in FIG. 5. However, the music-content list may include additional information other than the track-title information.

The second individual-list-and-executable-processing-option-display screen image 30 shows an option of one of the options for processing music contents belonging to the classification category Non-Secure Contents to make a copy of the music contents and transmit the copy to a universal-serial-bus (USB) memory. The above-described option is indicated by a sign that reads Copy via USB as shown in FIG. 5. The above-described option may be shown as a selectable operation button 34.

The second individual-list-and-executable-processing-option-display screen image 30 further shows an option of one of the options for processing music contents belonging to the classification category Non-Secure Contents to write data on the music contents onto a compact disk (CD). The above-described option is indicated by a sign that reads Burn on CD as shown in FIG. 5. The above-described option may be shown as a selectable operation button 35.

The second individual-list-and-executable-processing-option-display screen image 30 may further show an option of one of the options for processing music contents belonging to the classification category Non-Secure Contents to make a copy of the music contents and transmits the copy to bridge media including the SD-memory card or the like. The above-described option is indicated by a sign that reads Copy to Bridge Media as shown in FIG. 5. The above-described option may be shown as a selectable operation button 36.

The user can select a desired option by operating any of the operation buttons 34, 35, and 36 by using the input-operation unit 5.

In addition to the above-described configuration, the processing-device body 2 may further include a content-processing-execution unit 38 provided as a content-processing-execution device. The storage device 3 and the input-operation unit 5 are connected to the content-processing-execution unit 38.

Further, a device and/or media-at-the other-end 39 which receives the music-content processing may be connected to the content-processing-execution unit 38 of the processing-device body 2 by wire or wirelessly. The device and/or media-at-the-other-end 39 may be provided, as the home PC, the portable audio device, the SD memory card, the USB memory, the CD, or the bridge media.

When the user selects any of the music contents shown on the music-content list and any of options from the option list showing the processing executable for the music contents on the first individual-list-and-executable-processing-option-display screen image 20, the content-processing-execution unit 38 executes processing indicated by the selected option for the selected music contents. At that time, the above-described processing is destined for the device and/or media-at-the other-end 39.

For example, when the user selects music contents with a track title “CCC” and music contents with a track title “JJJ” by using the check boxes 21 and operates an operation button 27, thereby selecting an option on the first individual-list-and-executable-processing-option-display screen image 20 to move music contents to the SD-memory card, the two music contents “CCC” and “JJJ” are moved to the SD-memory card functioning, as the device and/or media-at-the other-end 39.

Further, when the user selects any of the music contents from among the music-content list and selects any of options shown on the option list showing processing executable for the music contents on the second individual-list-and-executable-processing-option-display screen image 30, the content-processing-execution unit 38 executes the processing indicated by the selected option for the selected music contents. At that time, the above-described processing is destined for the device and/or media-at-the other-end 39.

For example, when the user selects music contents with a track title “KKK” and music contents with a track title “LLL” by using the check boxes 31 and operates an operation button 35, thereby selecting an option on the second individual-list-and-executable-processing-option-display screen image 30 to write music contents onto a CD, the two music contents “KKK” and “LLL” are moved to the CD functioning as the device and/or media-at-the other-end 39.

In addition to the above-described configuration, the processing-device body 2 may include an audio-reproduction unit 40. The storage device 3, the input-operation unit 5, and the sound-output unit 7 are connected to the audio-reproduction unit 40.

The audio-reproduction unit 40 reads the music contents selected by the user operating the input-operation unit 5 from the storage device 3, converts the music contents into sound, and transmits the sound to the sound-output unit 7.

Next, one embodiment of a content-processing method will be described. The content-processing method can be executed using the above-described content-processing device 1.

When the content-processing device 1 is started, the content-list-and-rights-management-standard-drawing unit 8 reads the additional information and the rights-management-standard information of the music contents from the storage device 3, generates the content-list-and-rights-management-standard-drawing data by using the read information, and transmits the generated content-list-and-rights-management-standard-drawing data to the display-processing unit 9.

The display-processing unit 9 converts the content-list-and-rights-management-standard-drawing data into an image and produces the image on the display unit 6.

Subsequently, the total-display screen image 10 shown in FIG. 2 can be produced. By seeing the total-display screen image 10, the user can easily understand the rights-management standard corresponding to the music contents.

When the user selects the tag 12a to select the rights-management-standard-individual-display screen image 12 on the total-display screen image 10 by operating the input-operation unit 5, the rights-management-standard-list-drawing unit 11 reads information about the rights-management standard by which the right of the music contents is managed from the storage device 3, generates the rights-management-standard-list-drawing data by using the read information, and transmits the generated rights-management-standard-list-drawing data to the display-processing unit 9. The display-processing unit 9 converts the rights-management-standard-list-drawing data into an image and produces the image on the display unit 6.

Subsequently, the rights-management-standard-individual-display screen image 12 shown in FIG. 13 can be produced. When the user operates the operation button 14 to select a predetermined rights-management standard on the rights-management-standard-individual-display screen image 12 by operating the input-operation unit 5, the individual-list-and-executable-processing-option-drawing unit 18 reads the rights-management-standard information selected by the user and the additional information about the music contents managed by the rights-management standard selected by the user from the storage device 3.

Then, the individual-list-and-executable-processing-option-drawing unit 18 generates the first individual-list-and-executable-processing-option-drawing data by using the information read from the storage device 3 and transmits the generated first individual-list-and-executable-processing-option-drawing data to the display-processing unit 9. The display-processing unit 9 converts the first individual-list-and-executable-processing-option-drawing data into an image and produces the image on the display unit 6.

Subsequently, the first individual-list-and-executable-processing-option-display screen image 20 shown in FIG. 4 can be produced, and the user can easily find processing executable for the music contents managed by a desired rights-management standard by seeing the first individual-list-and-executable-processing-option-display screen image 20.

When the user selects any of the music contents shown on the music-content list and selects any of options shown on the option list showing processing executable for the music contents on the first individual-list-and-executable-processing-option-display screen image 20 by operating the input-operation unit 5, the content-processing-execution unit 38 executes the processing indicated by the selected option for the selected music contents. At that time, the above-described processing is destined for the device and/or media-at-the other-end 39.

Subsequently, the user can easily perform the executable processing appropriate for the rights-management standard for desired music contents.

On the other hand, when the user operates the operation button 15 to select a classification category indicating the music contents that are not managed by the rights-management standard, on the rights-management-standard-individual-display screen image 12 by operating the input-operation unit 5, the individual-list-and-executable-processing-option-drawing unit 18 reads the additional information about the music contents that are not managed by the rights-management standard from the storage device 3.

Then, the individual-list-and-executable-processing-option-drawing unit 18 generates the second individual-list-and-executable-processing-option-drawing data by using the information read from the storage device 3 and transmits the generated second individual-list-and-executable-processing-option-drawing data to the display-processing unit 9.

Subsequently, the second individual-list-and-executable-processing-option-display screen image 30 shown in FIG. 5 can be produced, and the user can easily find processing executable for the music contents that are not managed by the rights-management standard by seeing the second individual-list-and-executable-processing-option-display screen image 30.

When the user selects any of the music contents shown on the music-content list and selects any of options shown on the option list showing processing executable for the music contents on the second individual-list-and-executable-processing-option-display screen image 30 by operating the input-operation unit 5, the content-processing-execution unit 38 executes the processing indicated by the selected option for the selected music contents. At that time, the above-described processing is destined for the device and/or media-at-the other-end 39.

Subsequently, the user can easily perform the processing executable for the music contents that are not managed by the rights-management standard.

As has been described, according to the above-described embodiment, the user can easily find the rights-management standard appropriate for the music contents. Therefore, it becomes possible to easily perform executable processing appropriate for a predetermined rights-management standard and increase the convenience of the user.

The present invention can be achieved without being limited to the above-described embodiment, but can be modified in various ways, as required.

For example, even though a plurality of contents is managed by the same rights-management standard, processing executable for one of the plurality of contents may be different from that executable for the other contents. In that case, the option list showing processing executable for contents managed by a rights-management standard selected by the user may be individually shown for each of the contents managed by the selected rights-management standard.

In that case, for example, when the user selects different music contents by placing a checkmark in the check box 21 that had not been used on the individual-list-and-executable-processing-option-display screen image 20 shown in FIG. 4, the number of options 25, 26, and 27 indicating processing executable for the music contents shown on the individual-list-and-executable-processing-option-display screen image 20 and/or the details on the executable processing may change. The above-described processing may be executed by the individual-list-and-executable-processing-option-drawing unit 18.

According to the above-described configuration, the user can find the processing executable for desired music contents with increased stability. Here, the individual display of processing executable for the music contents may be performed for each of the music contents that are not managed by the rights-management standard.

Further, after the user selects a rights-management-standard on the rights-management-standard-individual-display screen image 12, the individual-list-and-executable-processing-option-drawing unit 18 and the display-processing unit 9 may produce the classification-category list provided to classify the music contents belonging to the rights-management standard selected by the user (hereinafter referred to as a classification-category list) on the display unit 6 so that the user can select any of the classification categories shown on the classification-category list.

In that case, the classification-category list may include a classification category indicating that a one-generation copy can be made, and a classification category indicating that the date and time where the music-content reproduction is performed are restricted, and so forth.

When the user selects any of the classification categories shown on the classification-category list, the individual-list-and-executable-processing-option-drawing unit 18 and the display-processing unit 9 may produce the classification-category list showing processing executable for the music contents belonging to the classification category selected by the user and the list of music contents belonging to the classification category selected by the user on the display unit 6.

Subsequently, it becomes possible to produce a music-content list and a list of options showing executable processing that are more adaptable to the user's needs than in the case where the individual-list-and-executable-processing-option-display screen image 20 is used.

In that case, both the list of options indicating processing executable for the contents managed by the selected rights-management standard and the list of contents managed by the rights-management standard selected by the user can be produced on the display unit 6.

The above-described operations performed by the individual-list-and-executable-processing-option-drawing unit 18 and the display-processing unit 9, the operations including the display of classification-category list, can be performed even though the classification category indicating that the music contents are not managed by the rights-management standard is selected on the rights-management-standard-individual-display screen image 12.

The present invention can be used for video contents. Further, the present invention can be used for an on-vehicle device and an apparatus other than the on-vehicle device, such as the home PC.

It is therefore intended that the foregoing detailed description be regarded as illustrative rather than limiting, and that it be understood that it is the following claims, including all equivalents, that are intended to define the spirit and scope of this invention.

What is claimed is:

1. A content-processing device comprising:
a content-storage unit configured to store contents;
a rights-management-standard-storage unit configured to store information about at least one rights-management standard for managing the stored contents;
an additional-information-storage unit configured to store additional information about the stored contents;
a content-list-display-processing unit configured to produce a list of the stored contents on a display unit based on the stored additional information; and
a rights-management-standard-display-processing unit configured to produce the stored rights-management-standard information and the content list on the display unit so that each of the at least one rights-management standard is shown in association with each of the contents shown on the content list.

2. The content-processing device according to claim 1, wherein the contents include at least one of sound data and video data.

3. The content-processing device according to claim 2, wherein the contents are music contents and the additional information includes at least one of track-title information, track-type information, and information about an artist's name.

4. The content-processing device according to claim 3, where the content-processing device is mounted on an on-vehicle device.

5. A content-processing device comprising:
a content-storage unit configured to store contents;
a rights-management-standard-storage unit configured to store information about at least one standard for managing the stored contents;
an additional-information-storage unit configured to store additional information about the stored contents; and
a content-individual-list-display-processing unit configured to produce a list of the stored contents on a display unit based on the stored additional information and the stored rights-management-standard information so that the content list is individually produced for each of the at least one rights-management standard.

6. The content-processing device according to claim 5, wherein the contents include at least one of sound data and video data.

7. The content-processing device according to claim 6, wherein the contents are music contents, and the additional information includes at least one of track-title information, track-type information, and information about an artist's name.

8. A content-processing device comprising:
a content-storage unit configured to store contents;
a rights-management-standard-storage unit configured to store information about at least one standard for managing the stored contents;
a rights-management-standard-list-display-processing unit configured to produce a list of the at least one rights-management standard on a display unit based on the stored rights-management-standard information so that a user can select any of the at least one rights-management standard shown on the rights-management-standard list; and
an executable-processing-option-display-processing unit configured to produce both an option list and a content list on the display unit when the user selects any of the at least one rights-management standard shown on the produced rights-management-standard list, where the option list shows at least one option indicating processing executable for contents managed by the selected rights-management standard and where the content list shows the contents managed by the selected rights-management standard.

9. The content-processing device according to claim 8, wherein the executable-processing-option-display-processing unit produces the list of the contents managed by the selected rights-management standard so that the user can select any of the contents shown on the content list and produces the list of the at least one option indicating the processing executable for the contents managed by the selected rights-management standard so that the user can select any of the at least one option shown on the option list, and
wherein the content-processing device further comprises a content-processing-execution unit configured to execute processing indicated by an option for contents when the user selects the contents from the list of the contents managed by the selected rights-management standard and the user selects the option from among the list of the at least one option indicating the processing executable for the contents managed by the selected rights-management standard.

10. The content-processing device according to claim 8, wherein the executable-processing-option-display-processing unit can produce the list of the at least one option indicating the processing executable for the contents managed by the selected rights-management standard so that the list can be individually produced for each of the contents managed by the rights-management standard.

11. The content-processing device according to claim 8, wherein the rights-management-standard-list-display-processing unit produces at least one classification category indicating contents that are not managed by the rights-management standard on the content-rights-management-standard list so that the user can select any of the at least one classification category, and
wherein when the user selects the classification category indicating the contents that are not managed by the rights-management standard from the content-rights-management-standard list, the executable-processing-option-display-processing unit is operative to produce both a list of at least one option indicating processing executable for the contents that are not managed by the rights-management standard and that belong to the classification category and a list of the contents that are not managed by the rights-management standard on the display unit.

12. The content-processing device according to claim 11, wherein the executable-processing-option-display-processing unit produces the list of the contents that are not managed by the rights-management standard so that the user can select any of the contents shown on the content list and produces the list of the at least one option indicating the processing executable for the contents that are not managed by the rights-management standard so that the user can select any of the at least one option shown on the option list, and
wherein the content-processing device further comprises a content-processing-execution unit configured to execute processing indicated by an option for contents when the user selects the contents from among the list of the contents that are not managed by the rights-management standard and the user selects the option from among the list of the at least one option indicating the processing executable for the contents that are not managed by the rights-management standard.

13. A content-processing method comprising:
displaying a list of contents on a display unit based on information about the contents such that both information about at least one rights-management standard for managing the contents and the content list are shown on the display unit so that each of the at least one right-management standard is shown in association with each of the contents shown on the content list.

14. A content-processing method comprising:
displaying a list of contents on a display unit based on information about the contents and information about at least one rights-management standard for managing the contents such that the content list is individually shown for each of the at least one content-rights-management standard.

15. A content-processing method comprising the steps of:
displaying a list of at least one rights-management standard for managing contents on a display unit such that a user can select any of the at least one rights-management standard shown on the rights-management-standard list; and
displaying both an option list and a content list on the display unit when the user selects any of the at least one rights-management standard from among the displayed content-rights-management-standard list, where the option list provides at least one option indicating processing executable for contents managed by the selected rights-management standard and where the content list shows the contents managed by the selected rights-management standard.

16. The content-processing method according to claim 15, further comprising the steps of:
displaying the list of the contents managed by the rights-management standard selected by the user such that the user can select any of the contents shown on the content list, and displaying the list of the at least one option indicating the processing executable for the contents managed by the selected rights-management standard such that the user can select any of the at least one option shown on the option list; and
executing processing indicated by an option for contents when the user selects the contents from among the list of the contents managed by the rights-management standard selected by the user and the user selects the option from among the list of the at least one option indicating the processing executable for the contents managed by the selected rights-management standard.

17. The content-processing method according to claim 15, further comprising:
displaying the list of the at least one option indicating the processing executable for the contents managed by the rights-management standard selected by the user such that the list is individually produced for each of the contents managed by the rights-management standard.

18. The content-processing method according to claim 15, further comprising:
displaying at least one content-classification category indicating contents that are not managed by the rights-management standard on the content-rights-management-standard list such that the user can select any of the at least one classification category, and
displaying a list of at least one option and a list of the contents that are not managed by the rights-management standard on the display unit when the user selects the content-classification category indicating the contents that are not managed by the rights-management standard from among the content-rights-management-standard list, where the option list shows processing executable for the contents that belong to the classification category and that are not managed by the rights-management standard.

19. The content-processing method according to claim 18, further comprising the steps of:
displaying the list of the contents that are not managed by the rights-management standard such that the user can select any of the contents shown on the content list and displaying the list of the at least one option indicating the processing executable for the contents that are not managed by the rights-management standard such that the user can select any of the at least one option shown on the option list, and
executing processing indicated by an option for contents when the user selects the contents from among the list of the contents that are not managed by the rights-management standard and the user selects the option from among the list of the at least one option indicating the processing executable for the contents that are not managed by the rights-management standard.

20. The content-processing method according to claim 15, wherein the contents are music contents, and the additional information includes at least one of track-title information, track-type information, and information about an artist's name.
